(19) United States
(12) Patent Application Publication
(10) Pub. No.: US 2004/0058106 A1
(43) Pub. Date: Mar. 25, 2004

(54) Packaged solvent-containing cosmetic composition

(76) Inventors: Erlinda Dugaduga Leone, Chestnut Ridge, NY (US); Robert Walter Sandewicz, Monroe Township, NJ (US)

Correspondence Address: Julie Blackburn, Revlon Consumer Products Corporation, 237 Park Avenue, New York, NY, 10017, US

(21) Appl. No.: 10/245,138

(22) Filed: Sep. 17, 2002

(51) Int. Cl. B32B 1/02

(52) U.S. Cl. 428/35.7

(57) ABSTRACT

A packaged cosmetic composition comprised of a solvent-containing cosmetic composition in an optically clear, self-supporting container comprised of a polycycloolefin resin.

### TECHNICAL FIELD

The invention is in the field of packaged cosmetic compositions.

### BACKGROUND OF THE INVENTION

One problem in the packaging of cosmetic compositions is that the composition itself may contain ingredients that react with chemical composition of the container. It is a common packaging problem to discover that the package into which the cosmetic formula is intended to be sold is not compatible with the cosmetic formula. This happens most often when the cosmetic compositions contain solvents—substances that present in the formula for the purpose of solvating other cosmetic ingredients. The most desirable cosmetic compositions often contain ingredients that in the strictest sense are not compatible with the other ingredients in the formula and require solvation in order to be properly formulated into the composition. For example, many of the resins and polymeric materials used in cosmetics are essential for forming a cosmetic film. Often these resins, by themselves, are insoluble or otherwise incompatible with the formula unless solvated by another ingredient in the cosmetic which is compatible with both the resin and the other ingredients in the formula. Nail enamels, transfer resistant lipsticks, and other types of long wearing color cosmetics provide examples of this phenomena. The solvents used to solvate the resins and polymers in these types of compositions often require that the composition be sold in glass containers. Glass is nearly inert and non-reactive with most, if not all, of the ingredients found in cosmetic formulas.

As might be imagined, however, glass containers have drawbacks. They are heavy, which results in significantly higher shipping costs. When millions of units are shipped in a year, the amount of money can be significant. Glass also breaks more readily than thermoplastic materials, and broken glass presents a number of different hazards.

For years cosmetics companies have been interested in finding suitable non-glass containers for packaging cosmetics. Containers made from thermoplastic polymeric materials such as HDPE (high density polyethylene), LDPE (low density polyethylene), styrene, and similar polymers are known. However, they suffer from a number of drawbacks, most notably that they are not optically clear. Packaging of cosmetic products requires that the containers be aesthetically pleasing. Any thermoplastic substitute for a glass container must provide aesthetic and functional properties equivalent to glass in terms of optical clarity, inertness, and appearance. Unfortunately, the plastic containers currently used for cosmetic compositions simply do not measure up. One chronic problem is that while the plastic may at first appear optically clear, after a time the cosmetic composition found within the container begins to interact with the thermoplastic material and yellowing of the container results. With respect to nail enamel in particular, the volatile organic solvents that are used are particularly reactive with thermoplastic materials. While there are commercial nail enamels that have been sold in plastic containers, the containers exhibited a yellowish cast, and in some cases the nail enamels had degraded the thermoplastic material used to make the container.

Accordingly, there is a need for cosmetic containers that provide the beneficial properties of glass containers, e.g. optical clarity and inertness, and at the same time are aesthetically pleasing, light weight, and suitable for use with a wide variety of cosmetic products. Such containers must also be easy to decorate according to the standard decorating methods used with cosmetic packaging. Most surprisingly, it has been discovered that cosmetic containers made from polycycloolefin resins are superior in terms of clarity, inertness, and aesthetics, and are suitable for use with solvent-containing cosmetic compositions.

It is an object of the invention to provide a packaged solvent-containing cosmetic composition in a container comprised of a polycycloolefin resin.

It is a further object of the invention to provide a method for storing and dispensing a solvent-containing cosmetic composition comprising storing the composition in a container comprised of a polycycloolefin resin.

It is a further object of the invention to provide, specifically, a packaged nail enamel composition comprised of a nail enamel composition contained in a thermoplastic container comprised of a polycyloolefin resin.

### SUMMARY OF THE INVENTION

The invention is directed to a packaged cosmetic composition comprised of a solvent-containing cosmetic composition contained in a container comprised of a polycycloolefin resin.

The invention is further directed to a method for storing and dispensing a solvent-containing cosmetic composition comprising storing the composition in a container comprised of a polycycloolefin resin.

The invention is further directed to a packaged nail enamel composition comprised of a nail enamel composition contained in a container comprised of a polycycloolfin resin.

### DETAILED DESCRIPTION

The preferred packaged cosmetic product of the invention comprises a solvent-containing cosmetic composition packaged in an optically clear, self-supporting container comprising a polycycloolefin resin.

I. The Solvent-Containing Cosmetic Composition

The term “solvent” means an ingredient that is operable to solvate another ingredient found in the cosmetic composition and render it soluble or compatible in the cosmetic composition. Whether an ingredient acts as a solvent will depend on the other ingredients that are in the cosmetic composition into which it is incorporated. The term “compatible” means, with respect to an ingredient, that it can be incorporated into a particular cosmetic composition without “kicking out” or destabilizing the composition.

Generally, the cosmetic composition stored in the package will comprise from about 0.001-99%, preferably about 0.005-85%, more preferably about 0.1-50% by weight of the total composition of one or more solvents.

In general there are three categories of solvents: volatile organic solvents, silicones, and hydrocarbons.

A. Volatile Organic Solvents

The term “volatile” means an ingredient having a vapor pressure of at least 2 mm. of mercury at 200 C.

Suitable volatile organic solvents include aliphatic or aromatic ketones such as acetone, diacetone alcohol, dihydroxyacetone, ethyl butyl valerolactone, methyl ethyl ketone, and the like; aliphatic or aromatic alcohols such as methanol, propanol, benzyl alcohol, butyl alcohol, t-butyl alcohol, butylene glycol, diethylene glycol, abietyl alcohol, propylene carbonate, hexyl alcohol, isopropanol, and the like; glycol ethers such as butoxyethanol, butoxypropanol, 3-methyl-3-methoxy-butanol, methoxypropanol; esters such as butyl acetate, ethyl acetate, 1-methoxy-2-propanol acetate; benzoates and the like.

B. Siloxanes

Suitable siloxane solvents include water soluble and water insoluble volatile or non-volatile siloxanes.

Volatiles silicones may be linear or cyclic. Cyclic silicones (or cyclomethicones) are of the general formula:

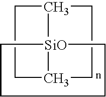

where n 3-7.

Linear volatile silicones in accordance with the invention have the general formula:

(CH₃)₃Si—O—[Si(CH₃)₂—O]ₙ—Si(CH₃)₃

where n=0-6, preferably 0-5.

Linear and cyclic volatile silicones are available from various commercial sources including Dow Corning Corporation and General Electric. The Dow Corning volatile silicones are sold under the tradenames Dow Corning 244, 245, 344, and 200 fluids. These fluids comprise octamethylcyclotetrasiloxane, decamethylcyclopentasiloxane, hexamethyldisiloxane, and mixtures thereof.

Suitable nonvolatile silicones include water insoluble silicones having a viscosity of 10 to 1,000,000 centistokes, preferably 20 to 600,000 centistokes at 25° C. Suitable water insoluble silicones include C₁₂₋₂₂ alkyl dimethicones, e.g. cetyl dimethicone, dimethicone, phenyl trimethiconei, phenyldimethicone, diphenyl dimethicone, and mixtures thereof. Such silicones are available from Dow Corning as the 3225C formulation aid, Dow 190, 193, or 200 fluids, or similar products marketed by Goldschmidt under the ABIL tradename.

Also suitable as the nonvolatile silicone oil are various fluorinated silicones such as trimethylsilyl endcapped fluorosilicone oil, polytrifluoropropylmethylsiloxanes, and similar silicones such as those disclosed in U.S. Pat. No. 5,118,496 which is hereby incorporated by reference.

A variety of water soluble silicones may also serve as solvents. Typically, these water soluble silicones are polydiorganosiloxane-polyoxyalkylene copolymers, which are in general referred to as dimethicone copolyol, C₁₂₋₂₂ alkyl dimethicone copolyols, dimethiconol, amodimethicone, and so on.

C. Hydrocarbons

Suitable hydrocarbons include esters, hydrocarbon oils, or an animal, vegetable, or mineral oils. Preferably, the hydrocarbon is a liquid at room temperature (25°C.) and preferably has a viscosity of about 10 to 600,000, preferably 20 to 500,000, more preferably 50 to 300,000 centipoise at 250 C.

1. Esters

Esters are suitable hydrocarbon compounds, including mono-, di-, and triesters.

(a). Monoesters

Monoesters are defined as esters formed by the reaction of a monocarboxylic acid having the formula R—COOH, wherein R is a straight or branched chain saturated or unsaturated alkyl having 2 to 30 carbon atoms, or phenyl; and an alcohol having the formula R—OH wherein R is a straight or branched chain saturated or unsaturated alkyl having 2-30 carbon atoms, or phenyl. Both the alcohol and the acid may be substitued with one or more hydroxyl groups, and in one preferred embodiment of the invention the acid is an alpha hydroxy acid. Either one or both of the acid or alcohol may be a “fatty” acid or alcohol, ie. may have from about 6 to 22 carbon atoms. Examples of monoester oils that may be used in the compositions of the invention include hexyldecyl benzoate, hexyl laurate, hexadecyl isostearate, hexyldecyl laurate, hexyldecyl octanoate, hexyldecyl oleate, hexyldecyl palmitate, hexyldecyl stearate, hexyldodecyl salicylate, hexyl isostearate, butyl isostearate, butyl oleate, butyl octyl oleate, cetyl palmitate, ceyl octanoate, cetyl laurate, cetyl lactate, cetyl isononanoate, cetyl stearate, stearyl lactate, stearyl octanoate, stearyl heptanoate, stearyl stearate, and so on. It is understood that in the above nomenclature, the first term indicates the alcohol and the second term indicates the acid in the reaction, i.e. stearyl octanoate is the reaction product of stearyl alcohol and octanoic acid. Preferred is monoester which is the reaction product of an aliphatic C₂₋₈ alcohol and a C₁₄₋₂₂ fatty acid, more particularly, the reaction product of a hexyl alcohol and lauric acid, also referred to as hexyl laurate.

(b). Diesters

Suitable diesters that may be used in the compositions of the invention are the reaction product of a dicarboxylic acid and an aliphatic or aromatic alcohol. The dicarboxylic acid may contain from 2 to 30 carbon atoms, and may be in the straight or branched chain, saturated or unsaturated form. The dicarboxylic acid may be subsituted with one or more hydroxyl groups. The aliphatic or aromatic alcohol may also contain 2 to 30 carbon atoms, and may be in the straight or branched chain, saturated, or unsaturated form. The aliphatic or aromatic alcohol may be substituted with one or more substitutents such as hydroxyl. Preferably, one or more of the acid or alcohol is a fatty acid or alcohol, i.e. contains 14-22 carbon atoms. The dicarboxylic acid may also be an alpha hydroxy acid. Examples of diester oils that may be used in the compositions of the invention include diisostearyl malate (the reaction product of isostearic alcohol and malic acid), neopentyl glycol dioctanoate (the reaction product of neopentyl glycol and 2-ethyl hexanoic acid), dibutyl sebacate (reaction product of butyl alcohol and sebacic acid), di-C₁₂₋₁₃ alkyl malate (reaction product of C₁₂₋₁₃ alcohol and malic acid), dicetearyl dimer dilinoleate (reaction product of cetearyl alcohol and adipic acid), dicetyl adipate (reaction product of cetyl acohol and adipic acid), diisocetyl adipate (reaction product of hexadecyl alcohol and adipic acid), diisononyl adipate (reaction product of isononyl alcohol and adipic acid), diisostearyl dimer dilinoleate (reaction product of isostearyl alcohol and dilinoleic acid), disostearyl fumarate (reaction product of isostearyl alcohol and fumaric acid), and so on.

(c). Triesters

Suitable triesters comprise the reaction product of a tricarboxylic acid and an aliphatic or aromatic alcohol. As with the mono- and diesters mentioned above, the acid and alcohol contain 2 to 30 carbon atoms, and may be saturated or unsatured, straight or branched chain, and may be substituted with one or more hydroxyl groups. Preferably, one or more of the acid or alcohol is a fatty acid or alcohol containing 14 to 22 carbon atoms. Examples of triesters include triarachidin (reaction product of glycerin and arachidic acid), tributyl citrate (reaction product of butyl alcohol and citric acid), tri C12-13 alkyl citrate (reaction product of C12-13 alcohol and citric acid), tricaprylin (reaction product of glycerin and caprylic acid), tricaprylyl citrate (reaction product of capryl alcohol and citric acid), tridecyl behenate (reaction product of tridecyl alcohol and behenic acid), trioctyldodecyl citrate (reaction product of octyldodecyl alcohol and citric acid), tridecyl behenate (reaction product of tridecyl alcohol and behenic acid), tridecyl cocoate (reaction product of tridecyl alcohol and coconut acid), tridecyl isononanoate (reaction product of tridecyl alcohol and isononanoate), and so on. Preferred is a triester which is the reaction product of an alpha hydroxy acid and a guerbet alcohol having 6 to 30 carbon atoms, in particular the reaction product of citric acid and octyldodecyl alcohol, referred to as trioctyldodecyl citrate.

2. Volatile Paraffinic Hydrocarbons

Examples of volatile hydrocarbon oils that may be used in the compositions of the invention include various straight or branched chain paraffinic hydrocarbons having 5 to 20 carbon atoms, more preferably 8-20 carbon atoms. Suitable hydrocarbons include pentane, hexane, heptane, decane, dodecane, tetradecane, tridecane, and C₈₋₂₀ isoparaffins as disclosed in U.S. Pat. Nos. 3,439,088 and 3,818,105, both of which are hereby incorporated by reference. Preferred volatile paraffinic hydrocarbons have a molecular weight of 70-225, preferably 160 to 190 and a boiling point range of 30 to 320, preferably 60-260 degrees C., and a viscosity of less than 10 cs. at 25 degrees C. Such paraffinic hydrocarbons are available from EXXON under the ISOPARS trademark, and from the Permethyl Corporation Suitable C₁₂ isoparaffins are manufactured by Permethyl Corporation under the tradename Permethyl. Another C₁₂ isoparaffin (isododecane) is distributed by Presperse under the tradename Permethyl. Various C₁₆ isoparaffins commercially available, such as isohexadecane (having the tradename Permethyl R), are also suitable.

3. Nonvolatile Hydrocarbon Oils

Suitable nonvolatile hydrocarbon oils include isoparaffins and olefins having greater than 20 carbon atoms. Examples of such hydrocarbon oils include C₂₄₋₂₈ olefins, C₃₀₋₄₅ olefins, C₂₀₋₄₀ isoparaffins, hydrogenated polyisobutene, mineral oil, pentahydrosqualene, squalene, squalane, and mixtures thereof.

(a). Lanolin Oil

Lanolin oil or derivatives thereof such as hydroxylated lanolin, isobutylated lanolin oil, acetylated lanolin, acetylated lanolin alcohol, and so on, are also known to be emollients that have solvent capability.

D. Types of Solvent-Containing Cosmetic Compositions

A wide variety of solvent-containing cosmetic compositions may be stored in the container of the invention, including but not limited to facial and body creams and lotions, toners, astringents, nail enamel, color cosmetic products such as eyeshadow, blush, lipstick, concealer, foundation makeup, and the like. Preferably, the container is used to store products that are usually found in glass containers, such as nail enamel, foundation makeup, lotions, and creams.

1. Nail Enamel

Particularly preferred is where the solvent-containing composition is a nail enamel. Nail enamels suitable for use in the claimed package generally contain about 5-95% solvent and about 1-95% of a film forming polymer. The solvent component typically contain one or more volatile organic solvents as mentioned above.

(a) The Film Forming Polymer

The nail enamel composition contained in the package may contain a wide variety of film forming polymers including cellulosic film formers, acrylate or methacrylate copolymers, etc. The term “film forming polymer” means a polymer that is soluble or dispersible in the solvent of the nail enamel composition and is capable of remaining soluble or dispersible, without settling out, in the composition, during the shelf life of the product.

(i) Cellulosic Film Formers

Suitable cellulosic film formers include nitrocellulose, cellulose acetate butyrate, cellulose acetate propionate, and the like.

(ii) Synthetic Polymers

(aa) Nonpolar Monomers

The film forming polymer may also comprise a homopolymer, or a copolymer of one or more different monomers. A variety of nonpolar monomers may be used, and the polymer may be comprised of more than one nonpolar monomer. In general, the nonpolar monomer is an ethylenically unsaturated monomer that is mono-, di-, tri-, or polyfunctional as regards the addition-polymerizable ethylenic bonds. A variety of ethylenically unsaturated monomers are suitable, so long as the monomers selected are nonpolar and capable of polymerization with the polar monomer to form a film forming polymer that is soluble or dispersible in the solvent of the nail enamel composition and which forms an adherent, permanent, non-water removable film on the nail after the nail enamel composition is applied to the nail and allowed to dry.

Monofunctional Monomers

Examples of suitable monofunctional ethylenically unsaturated monomers include those of the formula:

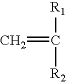

wherein R₁ is H, a C₁₋₃₀ straight or branched chain alkyl, aryl, aralkyl; R₂ is H, CH₃, a pyrrolidone, or a substituted or unsubstituted aromatic, alicyclic, or bicyclic ring where the substitutents are C₁₋₃₀ straight or branched chain alkyl, or COOM wherein M is a C₁₋₃₀ straight or branched chain alkyl, pyrrolidone, or a substituted or unsubstituted aromatic, alicylic, or bicyclic ring where the substitutents are C₁₋₃₀ straight or branched chain alkyl which may be substituted with one or more halogens.

Preferably, the monofunctional ethylenically unsaturated monomer is of Formula I, above, wherein R₁ is H or a C₁₋₃₀ alkyl, and R₂ is COOM wherein M is a C₁₋₃₀ straight or branched chain alkyl.

More preferably, R₁ is H or CH₃, and R₂ is COOM wherein M is a C₁₋₁₀ straight or branched chain alkyl. In the preferred embodiment of the invention, the monofunctional ethylenically unsaturated monomer comprises the monomer of Formula I wherein R₁ is CH₃ and R₂ is COOM where M is a C₄ alkyl, in particular butyl, and the monomer is butyl methacrylate.

Di-, tri- and polyfunctional monomers, as well as oligomers, of the above monofunctional monomers may also be used in the composition. Such di-, tri-, and polyfunctional monomers are generally known as cross-linking monomers because they aid in cross-linking of the monomer composition during and after polymerization.

Difunctional Monomers

Preferred difunctional monomers include those having the general formula:

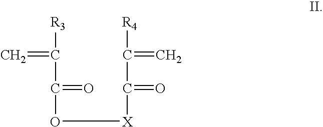

wherein R₃ and R₄ are each independently H, a C₁₋₃₀ straight or branched chain alkyl, aryl, or aralkyl; and X is [(CH₂)ₓO_{y}]_{z} wherein x is 3-20, and y is 1, and z is 1-100. Particularly preferred are difunctional acrylates and methacrylates, such as the compound of formula II above wherein R₃ and R₄ are CH₃ and X is [(CH₂)ₓO_{y}]_{z} wherein x is 1-4; and y is 1-20; and z is 1-10.

Particularly preferred are difunctional acrylates and methacrylates, such as the compound of formula II above wherein R₃ and R₄ are CH₃ and X is [(CH₂)ₓO_{y}]_{z} wherein x is 3; and y is 1, and z is 4. Examples of difunctional monomers include propylene glycol dimethacrylate or dipropylene glycol dimethacrylate.

Trifunctional and polyfunctional monomers are also suitable for use in the polymerizable monomer compositions of the invention. Examples of such monomers include acrylates and methacrylates such as trimethylolpropane trimethacrylate or trimethylolpropane triacrylate.

(bb) Polar Monomers

The film forming polymer may comprise one or more polar monomers. The term “polar monomer” means a monomer having a hydrophilic functional group which confers charge, or polarity, to the monomer Examples of hydrophilic functional groups that may be found on the polar monomer include hydroxy-polyethyleneoxy, hydroxyl, carboxylates such as carboxylic acid, sulfonates, sulfates, amines, or phosphates. These polar, hydrophilic functional groups may be anionic or cationic in charge. For example, hydroxy-polethyleneoxy, hydroxyl, carboxylates, sulfonates, phosphates, and sulfates tend to be anionic in charge, whereas most amines or amides will be cationically charged.

A variety of polar monomers are suitable, in particular, ethylenically unsaturated monomers such as acrylic acid esters or methacrylic acid esters substituted with one or more hydroxyl groups or hydroxy polyethylene-oxy groups; monomers containing carboxylic acid functional groups such as acrylic acid, methacrylic acid, and the like, amine functional acrylates and methacrylates, and so on. Preferably the polar monomer has the general formula:

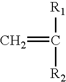

wherein R₁ is H, or a C₁₋₃₀ straight or branched chain alkyl, aryl, or aralkyl; and R₂ is COOM wherein M is H; (CHR₁)ₙOH; (CH₂CH₂O)ₙH, (CH₂)ⁿNR₁; (CHR₁CONR₁H) where n is 1-100.

Preferably, the polar monomer is acrylic acid or methacrylic acid, more preferably acrylic acid.

(b). Pigments

The nail enamel compositions of the invention may be pigmented or clear. If pigmented, generally 0.1-30% by weight of the total composition, preferably 0.5-20%, more preferably 1-15% of pigment is suggested. Pigments suitable for use in nail enamel compositions are well known and include iron oxides, D&C and FD&C colors, titanium dioxide, and the like. The pigments may be treated or coated with agents which modify the surface properties such as silicones. Examples of silicone treated pigments which can be used in the compositions of the invention are set forth in U.S. Pat. No. 4,832,944, which is hereby incorporated by reference.

(c). Suspending Agents

If the nail enamel compositions of the invention contain pigments, it is desirable to also incorporate 0.01-15%, preferably 0.05-10%, more preferably 0.1-8% by weight of the total composition of a suspending agent which acts to suspend the pigments in the formulation. Suitable suspending agents are montmorillonite minerals and derivatives thereof, such as stearalkonium bentonite, hectorites, attapulgite, bentones, and the like, as well as polymeric compounds known as associative thickeners. Suitable associative thickeners generally contain a hydrophilic backbone and hydrophobic side groups. Examples of such thickeners include polyacrylates with hydrophobic side groups, cellulose ethers with hydrophobic side groups, polyurethane thickeners. Examples of hydrophobic side groups are long chain alkyl groups such as dodecyl, hexadecyl, or octadecyl; alkylaryl groups such as octylphenyl or nonyphenyl.

(d) Defoaming Agents

Suitable defoaming agents for use in the composition include silicone glycol copolymers. Suggested ranges are 0.01-10%, preferably 0.05-8%, more preferably 0.1-5% by weight of the total composition. Silicone glycol copolymers which may be used in the compositions of the invention are polymethylsiloxanes wherein a portion of the methylsiloxane units are substituted with polyalkylene glycol ether moieities. Preferred is wherein about 60-90% of the polymer (the percentage being based on the number of monomer units), of the compound is polydimethylsiloxane or polyhydrogen methylsiloxane and 30-40% of the compound (the percentage being based upon the number of monomer units) is di-methyl or hydrogen-methyl siloxane units substituted with polyalkylene glycol ethers. Most preferred are silicone glycol copolymers having a viscosity ranging from 1.0 to 500,000, preferably 1.0 to 2,000 centipoise at 25° C., a specific gravity ranging from 0.80 to 1.030 at 25° C., and comprise approximately 80% dimethylsiloxane units and 20% propylene oxide substituted methyl siloxane units. Silicone glycol copolymers having this description are commercially available from a variety of sources including Dow Corning under the tradenames Dow Corning Additive 3, 7, 11, 14, 18, 21, 24, 26, 28, 29, 51, 54, 56, 57, and 1248.

(e) Plasticizers

The packaged nail enamel compositions may contain one more plasticizers that plasticize the film formed on the nail after the composition is applied to the nail and allowed to try. Suggested ranges of plasticizer are 0.1-35%, preferably 0.5-30%, more preferably 1-25% by weight of the total composition. Suitable plasticizers include glyceryl, glycol, and citrate esters as disclosed in U.S. Pat. No. 5,066,484, which is hereby incorporated by reference. Examples of such esters include glyceryl tribenzoate, glyceryl triacetate, acetyl tributyl citrate, dipropylene glycol dibenzoate, and the like. Also suitable, are plasticizers of the following general formula:

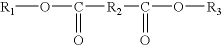

wherein R₁, R₂, and R₃ are each independently a C₁₋₂₀ straight or branched chain alkyl or alkylene which may be substituted with one or more hydroxyl groups. Preferably, R₁ is a C₃₋₁₀ straight or branched chain alkyl; R₂ is a C₂₋₈ alkyl which may be substituted with one or more hydroxyl groups; and R₃ is a C₃₋₁₀ straight or branched chain alkyl. Examples of such compounds include dioctyl malate, diisopropyl adipate, dibutyl sebacate, dioctyl azelate, dioctyl succinate, dioctyl fumarate, and the like. Preferred is where R₁ and R₃ are a branched C₈ alkyl, R₂ is a C₂ alkyl substituted with one hydroxy group, which is dioctyl malate.

2. Foundation Makeup

Foundation makeup may be incorporated into the packaged cosmetic composition of the invention. Generally foundation makeups are in the emulsion form, either water-in-oil or oil-in-water emulsion. Typical water and oil emulsions comprise about 0.1-99% water and 0.1-99% oil, in addition to pigments which color the composition, and surfactants which facilitate the formation of stable emulsions, and other ingredients such as film forming polymers, solvents, botanical extracts, and the like.

Typical foundation makeup compositions comprise water and oil emulsions containing about 0.1-95% water and about 5-99% of an oily material (which preferably includes one or more solvents), 0.1-25% pigment, and 0.1-20% film forming polymer, and 0.01-15% surfactant. The ingredients which require solvation include the film forming polymers which may include those set forth above with respect to the nail enamel composition, in addition to those set forth below:

(a). Resinous Plant Extracts

Examples of resinous plant extracts that provide film forming properties include materials such as rosin and shellac, or derivative thereof.

(b). MQ Resinous Film Formers

Suitable synthetic polymers may be MQ silicones, which means silicone polymers comprised of monofunctional and quadrifunctional siloxane units. Particularly preferred are siloxy silicate polymers having the following general formula.

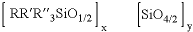

wherein R, R′ and R″ are each independently a C₁₋₁₀ straight or branched chain alkyl or phenyl, and x and y are such that the ratio of (RR′R″)₃SiO_{1/2} units to SiO₂ units is 0.5 to 1 to 1.5 to 1.

Preferably R, R′ and R″ are each a C₁₋₆ alkyl, and more preferably are methyl and x and y are such that the ratio of (CH₃)₃SiO_{1/2} units to SiO_{4/2} units is about 0.75 to 1. Most preferred is this trimethylsiloxy silicate containing 2.4 to 2.9 weight percent hydroxyl groups, which is formed by the reaction of the sodium salt of silicic acid, chlorotrimethylsilane, and isopropyl alcohol. The manufacture of trimethylsiloxy silicate is set forth in U.S. Pat. Nos. 2,676,182; 3,541,205; and 3,836,437, all of which are hereby incorporated by reference. Trimethylsiloxy silicate as described is available from Dow Corning Corporation under the tradename 2-0749 and 2-0747, which is a blend of about 40-60% volatile silicone and 40-60% trimethylsiloxy silicate. Dow Corning 2-0749 in particular, is a fluid containing about 50% trimethylsiloxy silicate and about 50% cyclomethicone. The fluid has a viscosity of 200-700 centipoise at 25° C., a specific gravity of 1.00 to 1.10 at 25° C., and a refractive index of 1.40-1.41.

Also suitable are synthetic polymers obtained by polymerizing various types of ethylenically unsaturated monomers. These types of polymers are often found in the form of an aqueous dispersion where the polymer particles are dispersed in the aqueous phase of the polymer emulsion. Examples of such polymers include homo- or copolymers of monomers such as acrylic acid, methacrylic acid or C₁₋₃₀ esters of acrylic or methacrylic acid, vinyl pyrrolidone, vinyl acetate, urethane, C₁₋₃₀ hydroxy esters of acrylic or methacrylic acid, vinyl isodecanoate, styrene, and olefins such as ethylene, propylene, butene, pentene, decene, hexadecene, and so on.

3. Toners/Astringents

Toners and/or astringents may be incorporated into the packaged cosmetic composition of the invention. These types of cosmetics generally contain one or more solvents in an aqueous medium. They are used to cleanse and tone skin. Typical compositions comprise 0.1-99% water, and bout 0.1-99% one or more solvents, and other ingredients such as humectants, surfactants, botanical extracts, and the like.

4. Skin Lotions and Creams

It is particularly desirable to package skin and body lotions and creams in the claimed package, which is an excellent substitute for the glass containers typically used to package prestige creams and lotions. Typical creams and lotions are also in the emulsion form and generally contain from about 0.1-99% water and 0.1-99% oil, in addition to surfactants, humectants, film formers, botanical extracts, and the like.

Other cosmetic compositions may also be packaged in the container. In general, any type of cosmetic composition usually packaged in glass and for which alternate non-glass packaging is desired is suitable.

II. The Container

The container into which the solvent-containing cosmetic composition is stored is made from a polycycloolefin resin. The container is optically clear and self-supporting. The term “self-supporting” means that the container is not in a compressible form, such as a gel pack or the like, but rather if placed on a solid, flat surface will be able to hold its place and maintain its shape.

Preferably, the polycycloolefin resin is prepared by polymerizing the following monomers of the formula I or II:

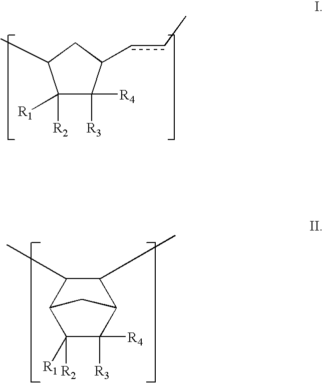

wherein R₁, R₂, R₃, and R₄ are each independently hydrogen, hydrocarbon, halogen, hydroxy, ester, alkoxy, cyano, amido, imido, or silyl, or a hydrocarbon substituted with hydrogen, hydrox, ester, alkoxy, cyano, amido, imido, or silyl, provided that two or more of R₁, R₂, R₃, or R₄ may combine with each other to form an unsaturated bond, single ring, or multi-ring, the single ring or multi ring may have a double bond or may form an aromatic ring, and R₁ and R₂ together may form an alkylidene group or R₃ and R₄ together may form an alkylidene group; either alone or in combination with bridging groups of the general formula:

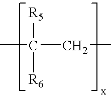

wherein R₅ and R₆ are each independently hydrogen, alkyl, or aryl, and x is from 1-1000.

More preferably the polycycloolefin resin has a refractive index of greater than 1.5, a glass transition temperature of about 100 to 160° C., a tensile strength of about 61, a tensile modulus of about 2400, and a tensile elongation of about 20. The most preferred container has a refractive index of 1.53 and a glass transition temperature of 136° C. Preferred polycycloolefin resins are made by Zeon chemicals under the Zeonor and Zeonex trademarks. Zeonor 1410R is the most preferred polycycloolefin resin.

The polycycloolefin resin may be used to make a wide variety of suitable containers, including bottles, boxes, jars, or any other form suitable for storing the solvent-containing cosmetic products. The containers may be made in a variety of ways, including blow molding or by separate molding of individual pieces which are assembled prior to use.

Containers are prepared by blow molding the polycycloolefin resin in the standard manner known for blow molding plastic containers and other types of implements.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims.

We claim:

1. A packaged cosmetic composition comprised of a solvent-containing cosmetic composition in an optically clear, self-supporting container comprised of a polycycloolefin resin.

2. The package of claim 1 wherein the solvent comprises a volatile organic solvent, a siloxane solvent, or a hydrocarbon solvent.

3. The package of claim 1 wherein the volatile organic solvent has a vapor pressure of at least about 2 mm. of mercury at 20° C.

4. The package of claim 3 wherein the volatile organic solvent comprises ketones, ethers, C₁₋₄ alkanols, esters of C₁₋₆ alkanols and C₁₋₆ acids, or mixtures thereof.

5. The package of claim 4 wherein the cosmetic composition is nail enamel.

6. The package of claim 1 wherein the solvent comprises a siloxane, hydrocarbon, or mixtures thereof.

7. The package of claim 6 wherein the cosmetic composition comprises foundation makeup.

8. The package of claim 1 wherein the container is prepared by blow molding.

9. The package of claim 1 wherein the polycycloolefin resin is obtained by polymerizing one or more monomers of the formula I or II: 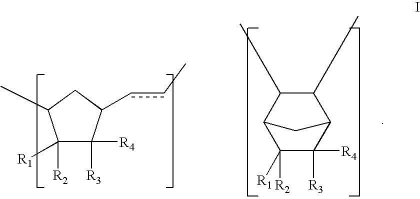
wherein R₁, R₂, R₃, and R₄ are each independently hydrogen, hydrocarbon, halogen, hydroxy, ester, alkoxy, cyano, amido, imido, or silyl, or a hydrocarbon substituted with hydrogen, hydrox, ester, alkoxy, cyano, amido, imido, or silyl, provided that two or more of R₁, R₂, R₃, or R₄ may combine with each other to form an unsaturated bond, single ring, or multi-ring, the single ring or multi ring may have a double bond or may form an aromatic ring, and R₁ and R₂ together may form an alkylidene group or R₃ and R₄ together may form an alkylidene group; either alone or in combination with bridging groups of the general formula: 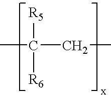
wherein R₅ and R₆ are each independently hydrogen, alkyl, or aryl, and x is from 1-1000.

10. The package of claim 9 wherein the polycycloolefin resin has a glass transition temperature ranging from about 100 to 160° C.

11. The package of claim 9 wherein the polycycloolefin resin has a refractive index of greater than 1.50.

12. The package of claim 1 wherein the container is a nail enamel bottle.

13. The package of claim 1 wherein the container is a foundation makeup bottle.

14. The package of claim 1 wherein the container is a toner or astringent bottle.

15. The package of claim 1 wherein the cosmetic composition is a lotion or a cream.

16. A packaged nail enamel composition comprising 1-95% solvent and 1-95% film forming polymer contained in an optically clear self-supporting bottle comprised of a polycycloolefin resin obtained by polymerizing one or more monomers of the formula I or II: 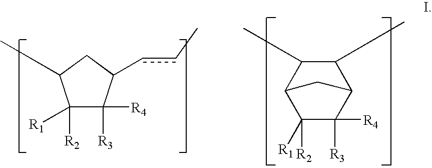
wherein R₁, R₂, R₃, and R₄ are each independently hydrogen, hydrocarbon, halogen, hydroxy, ester, alkoxy, cyano, amido, imido, or silyl, or a hydrocarbon substituted with hydrogen, hydrox, ester, alkoxy, cyano, amido, imido, or silyl, provided that two or more of R₁, R₂, R₃, or R₄ may combine with each other to form an unsaturated bond, single ring, or multi-ring, the single ring or multi ring may have a double bond or may form an aromatic ring, and R₁ and R₂ together may form an alkylidene group or R₃ and R₄ together may form an alkylidene group; either alone or in combination with bridging groups of the general formula: 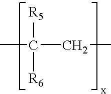
wherein R₅ and R₆ are each independently hydrogen, alkyl, or aryl, and x is from 1-1000.

17. The package of claim 16 wherein the container has a refractive index of greater than 1.50.

18. The package of claim 16 wherein the polycycloolefin resin has a glass transition temperature ranging from about 100 to 160° C.

19. The package of claim 16 wherein the nail enamel further comprises one or more pigments.

20. The package of claim 19 wherein the nail enamel composition further comprises one or more plasticizers.
